(19) United States
(12) Patent Application Publication
(10) Pub. No.: US 2017/0010701 A1
(43) Pub. Date: Jan. 12, 2017

(54) TOUCH PANEL

(71) Applicant: HIMAX TECHNOLOGIES LIMITED, Tainan City (TW)

(72) Inventors: Cheng-Hung Tsai, Tainan City (TW); Wai-Pan Wu, Tainan City (TW); Shen-Feng Tai, Tainan City (TW)

(21) Appl. No.: 14/794,113

(22) Filed: Jul. 8, 2015

(51) Int. Cl. G06F 3/041; G06F 3/044

(52) U.S. Cl. CPC G06F 3/041; G06F 3/044; G06F 2203/04107; G06F 2203/04112

(57) ABSTRACT

A touch panel, including a lower film layer, an upper film layer, a protective layer, and a plurality of sensing units, is provided. The upper film layer is disposed on the lower film layer. The protective layer is disposed on the upper film layer. One of the sensing units includes a first sensing electrode, a second sensing electrode, and a charge-locked electrode. The first sensing electrode is disposed in the lower film layer. The second sensing electrode is disposed in the upper film layer, and at least partially overlaps the first sensing electrode. The charge-locked electrode is disposed in the upper film layer, and at least partially overlaps the second sensing electrode. The first sensing electrode, the second sensing electrode, and the charge-locked electrode do not contact each other. The charge-locked electrode 136 is coupled to or floating-connect to a constant voltage.

### BACKGROUND OF THE INVENTION

1. Field of the Invention

The invention relates to a touch panel, and particularly relates to a layout structure of a capacitive touch panel.

2. Description of Related Art

Input devices of the information technology products have been changed from conventional keyboards and mice to touch panels so as to cope with the demands for convenience, miniaturization, and being user-friendly. At present, the touch panels can be generally classified into capacitive, resistive, optical, acoustic-wave and electromagnetic touch panels. Among these touch panels, the resistive touch panels and the capacitive touch panels are most common.

Taking capacitive touch panels as an example, the capacitive touch panel has a plurality of sensing electrodes, a plurality of signal lines, and a controller. When the user does not touch the touch panel, there is a capacitance initial value between the sensing electrodes. When the user touches the touch panel, the touched sensing electrode may generate a mutual capacitance, thereby changing the original capacitance initial value. At this time, the controller may determine the user's touch position by identifying the position of the electrode whose capacitance value is changed.

When the user holds the information technology product, a touch object (e.g., the user's finger) and the information technology product are connected to the same reference voltage (e.g., ground voltage). Thus, when the user holds the information technology product, the controller may easily identify the user's touch position. When the user does not hold the information technology product, the information technology product is likely in a floating-connecting state (i.e., low ground mode). Thus, the reference voltage of the information technology product may be different from the voltage of the touch object (e.g., the user's finger or a touch pen). Thus, when the user does not hold the information technology product, the controller may not easily identify the user's touch position.

### SUMMARY OF THE INVENTION

The invention provides a touch panel capable of improving a touch sensitivity in a non-handheld environment.

According to an embodiment of the invention, the touch panel includes a lower film layer, an upper film layer, a protective layer, and a plurality of sensing units. The upper film layer is disposed on the lower film layer. The protective layer is disposed on the upper film layer. One of the sensing units includes a first sensing electrode, a second sensing electrode, and a charge-locked electrode. The first sensing electrode is disposed in the lower film layer. The second sensing electrode is disposed in the upper film layer, and at least partially overlaps the first sensing electrode. The charge-locked electrode is disposed in the upper film layer, and at least partially overlaps the second sensing electrode. The first sensing electrode, the second sensing electrode, and the charge-locked electrode do not contact each other. The charge-locked electrode 136 is coupled to or floating-connect to a constant voltage.

Based on above, in the touch panel according to the embodiments of the invention, the charge-locked electrode (an electrode floating-connected or coupled to a constant voltage) is additionally disposed between the first sensing electrode and the touch object, so as to absorb the capacitance of the first sensing electrode through the touch object. Accordingly, the touch sensitivity of the touch panel according to the embodiments may be improved in the non-handheld environment.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a layout structure of a touch panel according to an embodiment of the invention.

FIG. 2 is a schematic view illustrating capacitances of a touch panel and a touch object when the user holds an information technology product having the touch panel.

FIG. 3 is a schematic view illustrating capacitances of a touch panel and a touch object when the user does not hold an information technology product having the touch panel.

FIG. 4 is a schematic view illustrating a layout structure of a touch panel according to another embodiment of the invention.

FIG. 5 is a schematic view illustrating a layout structure of a touch panel according to yet another embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Throughout the specification (including claims), the term “coupling” may refer to any direct or indirect connection means. For example, if it is described that a first device is coupled to a second device, it shall be appreciated that the first device may be directly connected to the second device, or the first device may be indirectly connected to the second device through another device or a certain connection means. Moreover, wherever possible, elements/components/steps with same reference numerals represent same or similar parts in the drawings and embodiments. Elements/components/steps referred to by the same terms or reference numerals in different embodiment may be referred to each other for relevant description.

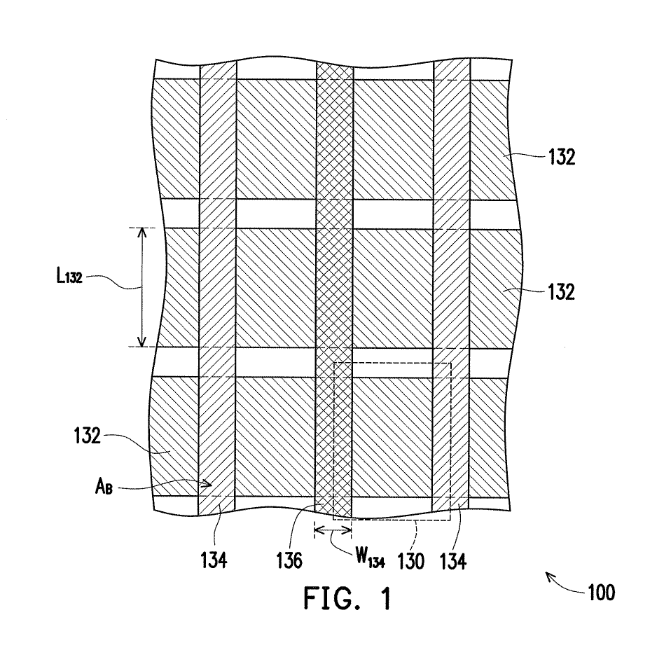

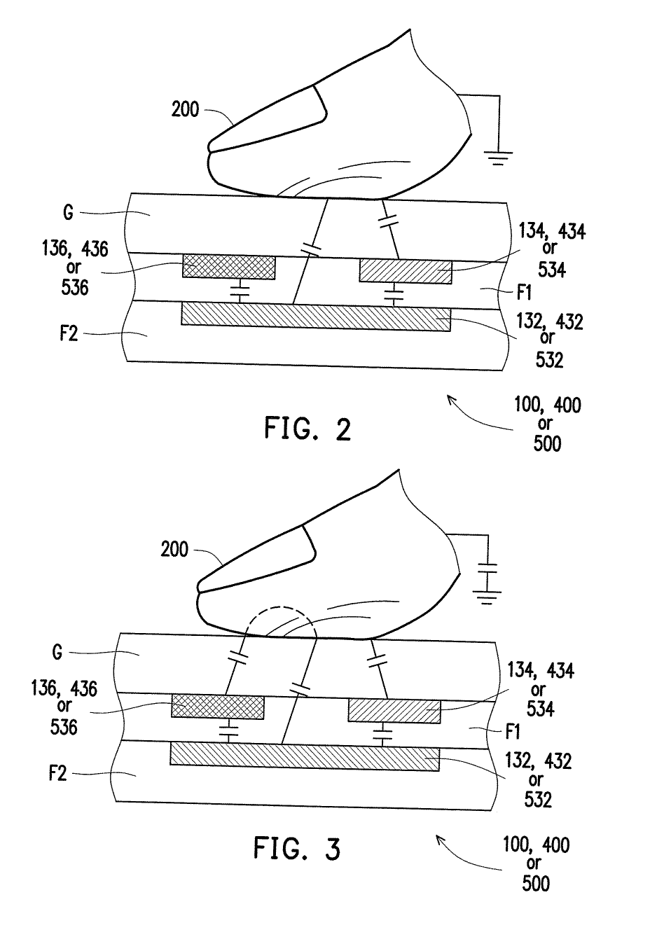

FIG. 1 is a schematic view illustrating a layout structure of a touch panel 100 according to an embodiment of the invention. FIGS. 2 and 3 are schematic cross-sectional views illustrating touch panels shown in FIG. 1, 4, or 5. Referring to FIGS. 1 and 2, the bar type touch panel 100 includes a protective layer G, an upper film layer F1, a lower film layer F2, and a plurality of sensing units 130. The upper film layer F1 is disposed on the lower film layer F2. The protective layer G is disposed on the upper film layer F1. Materials of the protective layer G, the upper film layer F1, and/or the lower film layer F2 may be any non-conductive material, such as glass, plastic, or other electrically insulating materials. Based on different requirements, the protective layer G, the upper film layer F1, and/or the lower film layer F2 may be formed of a transparent or non-transparent material.

Any one of the sensing units 130 includes a first sensing electrode 132, a second sensing electrode 134, and a charge-locked electrode 136. Materials of the first sensing electrode 132, the second sensing electrode 134, and the charge-locked electrode 136 may be any conductive material, such as a transparent conductive material like indium tin oxide (ITO), or a non-transparent material like metal. The first sensing electrode 132 is disposed in the lower film layer F2. The second sensing electrode 134 is disposed in the upper film layer F1, and at least partially overlaps the first sensing electrode 132. The charge-locked electrode 136 is disposed in the upper film layer F1, and at least partially overlaps the second sensing electrode 132. The first sensing electrode 132, the second sensing electrode 134, and the charge-locked electrode 136 do not contact each other.

The first sensing electrode 132 and the second sensing electrode 134 are arranged in a staggered manner and insulated from each other. The first sensing electrode 132 and the charge-locked electrode 136 are arranged in a staggered manner and insulated from each other. In this embodiment, a width L₁₃₂ of the first sensing electrode 132 may be 4.5 mm, and a width W₁₃₄ of the second sensing electrode 134 and/or the charge-locked electrode 136 may be 1 mm. A position where the first sensing electrode 132 and the second sensing electrode 134 overlap has an overlapped area A_{B}. Specifically, the overlapped area A_{B}=L₁₃₂*W₁₃₄=4.5 mm². The first sensing electrode 132 and the second sensing electrode 134 form a parallel-plate capacitor in the overlapped area A_{B}. According to a formula of parallel-plate capacitor, a capacitance C=∈*A/d, wherein s represents a dielectric constant of a dielectric layer between the parallel plates (the first sensing electrode 132 and the second sensing electrode 134 in this embodiment), A represents the overlapped area A_{B} of the first sensing electrode 132 and the second sensing electrode 134, and d represents a distance between the first sensing electrode 132 and the second sensing electrode 134. When the user does not touch the touch panel 100, the parallel-plate capacitor has a first capacitance initial value. The sensing unit 130 has a greater first capacitance initial value when the overlapped area A_{B} is larger.

The charge-locked electrode 136 is configured to be coupled to or floating-connect to a constant voltage. For example (however, the invention is not limited thereto), in some embodiments, the charge-locked electrode 136 may be constantly connected to a ground voltage. In some other embodiments, the charge-locked electrode 136 may be connected to any reference voltage having a constant level. In other embodiments, the charge-locked electrode 136 may be floating-connected. Namely, the charge-locked electrode 136 is not connected to any conductive material or electrical component. Thus, the charge-locked electrode 136 may not serve as a driving electrode or a receiving electrode.

The first sensing electrode 132 and the second sensing electrode 134 are respectively electrically connected to a controller (not shown) through different signal lines. Based on different design requirements, in some embodiments, the first sensing electrode 132 may be a driving electrode (also referred to as Tx electrode), while the second sensing electrode 134 may be a receiving electrode (also referred to as Rx electrode). In some other embodiments, the first sensing electrode 132 may be a receiving electrode, and the second sensing electrode 134 may be a driving electrode. When a touch object (e.g., the user's finger or a touch pen) touches the sensing array 220 to make a touched position (e.g., the position of the sensing unit 130 as indicated in FIG. 1) generate a capacitance change, the touch panel 100 may transmit a capacitance change signal output by the sensing unit 130 to the controller (not shown), so as to determine a touch position of the touch object.

FIG. 2 is a schematic view illustrating capacitances of the touch panel 100 and a touch object 200 (e.g., the user's finger or a touch pen) when the user holds an information technology product having the touch panel 100. A parallel-plate capacitor is formed between the first sensing electrode 132 and the second sensing electrode 134, and another parallel-plate capacitor is formed between the first sensing electrode 132 and the charge-locked electrode 136. When the touch object 200 touches (or approaches) the touch panel 100, a parasitic capacitance is formed between the first sensing electrode 132 and the touch object 200, and another parasitic capacitance is formed between the second sensing electrode 134 and the touch object 200. In the scenario shown in FIG. 2, the charge-locked electrode 136 is constantly connected to the ground voltage. When the user holds the information technology product having the touch panel 100, the touch object 200 and the touch panel 100 share the same ground voltage. When the touch object 200 touches the touch panel 100 to make the touched position generate a change of capacitance, the touched sensing unit 130 may immediately transmit the capacitance change signal to the controller (not shown) through the signal line to determine the user's touch position. When the user holds the information technology product, the controller (not shown) may easily identify the user's touch position.

FIG. 3 is a schematic view illustrating capacitances of the touch panel 100 and the touch object 200 (e.g., the user's finger or a touch pen) when the user does not hold an information technology product having the touch panel 100. Under a circumstance that the user does not hold the information technology product having the touch panel 100, the reference voltage of the touch panel 100 may be in a floating-connecting state (i.e., low ground mode (LGND mode)), such that the reference voltage of the touch panel 100 may be different from a voltage of the touch object 200. Under this circumstance, the charge-locked electrode 136 between the first sensing electrode 132 and the touch object 200 may absorb a capacitance of the first sensing electrode 132 through the touch object 200 and reduce a mutual capacitance path where the first sensing electrode 132 is serially connected to the second sensing electrode 134 through the touch object 200. Regarding an application of the ultra-slim protective layer G, the charge-locked electrode 136 may improve a variance of mutual capacitance, increase a signal-to-noise ratio (SNR), and help reduce a chance/probability that a ghost point occurs. Accordingly, a touch sensitivity of the touch panel 100 in a non-handheld environment may be improved.

Exemplary data are provided in the following to demonstrate characteristics of the touch panel 100 shown in FIG. 1. However, it should be noted that the embodiment of the touch panel 100 is not limited thereto. Here, it is assumed that a dielectric constant of the protective layer G is 7.4, a thickness of the protective G is 0.4 mm, a dielectric constant of an adhesive layer (not shown) between the protective layer G and the upper film layer F1 is 3.92, a thickness of the adhesive layer is 0.1 mm, a dielectric constant of the upper film layer F1 is 3.9, a thickness of the upper film layer F1 is 0.045 mm, a dielectric constant of the lower film layer F2 is 3.28, and a thickness of the lower film layer F2 is 0.05 mm. Besides, the first sensing electrode 132 serves as a driving electrode (also referred to as Tx electrode) here, while the second sensing electrode 134 serves as a receiving electrode (also referred to as Rx electrode) here. Table 1 illustrates capacitance values of the sensing unit 130 when the touch panel 100 is not touched. Table 1 also illustrates capacitance values of the sensing unit of the touch panel 100 when the charge-locked electrode 136 of the touch panel 100 is removed.

TABLE 1
Capacitance values when the touch panel 100 shown in FIG. 1
is not touched

| | Self- | Self- | |
|---|---|---|---|
| | capacitance | capacitance | Mutual |
| | (pF) of Tx | (pF) of Rx | capacitance |
| | Electrode | Electrode | (pF) |
| Charge-locked | 4.66 | 3.44 | 2.88 |
| electrode not disposed | | | |
| Charge-locked | 6.33 | 3.43 | 2.83 |
| electrode disposed | | | |

Table 2 illustrates capacitance values of the sensing unit 130 when the touch object 200 touches the touch panel 100. When a diameter of the touch object 200 is 22 mm (22 phi), and the user holds the information technology product having the touch panel 100, a mutual capacitance variance ΔC of the sensing unit 130 having the charge-locked electrode 136 is 0.059 pF, and the mutual capacitance variance ΔC of the sensing unit without the charge-locked electrode 136 is 0.045 pF. When the diameter of the touch object is 22 mm (22 phi), and the user does not hold the information technology product having the touch panel 100, the mutual capacitance variance ΔC of the sensing unit 130 having the charge-locked electrode 136 is −0.08 pF, and the mutual capacitance variance ΔC of the sensing unit without the charge-locked electrode 136 is −0.19 pF. When the diameter of the touch object 200 is 7 mm (7 phi), and the user holds the information technology product having the touch panel 100, the mutual capacitance variance ΔC of the sensing unit 130 having the charge-locked electrode 136 is 0.02 pF, and the mutual capacitance variance ΔC of the sensing unit without the charge-locked electrode 136 is 0.007 pF. When the diameter of the touch object is 7 mm (7 phi), and the user does not hold the information technology product having the touch panel 100, the mutual capacitance variance ΔC of the sensing unit 130 having the charge-locked electrode 136 is −0.019 pF, and the mutual capacitance variance ΔC of the sensing unit without the charge-locked electrode 136 is −0.052 pF.

TABLE 2
Capacitance values when the touch object 200 touches the touch panel 100
shown in FIG. 1

| | 22 phi | | 7 phi | |
|---|---|---|---|---|
| | Mutual | Mutual | Mutual | Mutual |
| | capacitance | capacitance | capacitance | capacitance |
| | variance (pF) in | variance (pF) in | variance (pF) in | variance (pF) in |
| | handheld | non-handheld | handheld | non-handheld |
| | condition | condition | condition | condition |
| Charge-locked | 0.045 | −0.19 | 0.007 | −0.052 |
| electrode not | | | | |
| disposed | | | | |
| Charge-locked | 0.059 | −0.08 | 0.02 | −0.019 |
| electrode disposed | | | | |

Table 3 illustrates mutual capacitance characteristic values of different sensing units 130 of the touch panel 100 when the touch object 200 of 22 phi (diameter thereof is 22 mm) touches the center of the touch panel 100 having the charge-locked electrode 136. Table 4 illustrates mutual capacitance characteristic values of different sensing units when the touch object 200 of 22 phi (diameter thereof is 22 mm) touches the center of the touch panel 100 without the charge-locked electrode 136. Here, Rx1, Rx2, Rx3, Rx4, Rx5, Rx6, Rx7, Rx8, Rx9, and Rx10 represent different second sensing electrodes 134, while Tx1, Tx2, Tx3, Tx4, Tx5, Tx6, Tx7, Tx8, Tx9, and Tx10 represent different first sensing electrodes 132. Based on Tables 3 and 4, it can be seen that the mutual capacitance characteristic values (e.g., the mutual capacitance characteristic values −50, −40, −42, and -38 at the position of the touch object 200) of the touch panel 100 having the charge-locked electrode 136 are greater than the mutual capacitance characteristic values (e.g., the mutual capacitance characteristic values −79, −110, −83, and -110) of the touch panel 100 without the charge-locked electrode 136. It can thus be known that the charge-locked electrode 136 may improve the mutual capacitance variance. Accordingly, the touch sensitivity of the touch panel 100 having the charge-locked electrode 136 in the non-handheld environment may be improved.

TABLE 3
Mutual capacitance characteristic values of different sensing units when a 22
phi touch object touches the touch panel 100 having the charge-locked electrode.

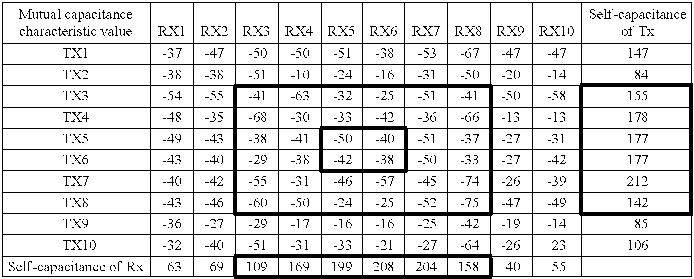

TABLE 4
Mutual capacitance characteristic values of different sensing units when a 22
phi touch object touches the touch panel 100 with the charge-locked electrode removed.

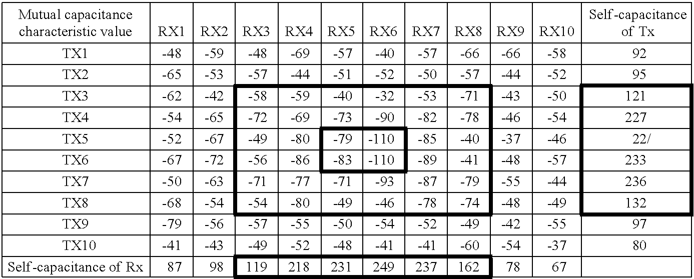

Table 5 illustrates mutual capacitance characteristic values of different sensing units 130 of the touch panel 100 when the touch object 200 of 7 phi (diameter thereof is 7 mm) touches the touch panel 100 having the charge-locked electrode 136. Table 6 illustrates mutual capacitance characteristic values of different sensing units when the touch object 200 of 7 phi (diameter thereof is 7 mm) touches the touch panel 100 without the charge-locked electrode 136. Based on Tables 5 and 6, it can be seen that the mutual capacitance characteristic values (e.g., the mutual capacitance characteristic values −17, −11, −9 and -2 at the position of the touch object 200) of the touch panel 100 having the charge-locked electrode 136 are greater than the mutual capacitance characteristic values (e.g., the mutual capacitance characteristic values −11, −39, −14 and −40) of the touch panel 100 without the charge-locked electrode 136. It can thus be known that the charge-locked electrode 136 may improve the mutual capacitance variance. Accordingly, the touch sensitivity of the touch panel 100 having the charge-locked electrode 136 in the non-handheld environment may be improved, and a coaxial effect may be reduced.

TABLE 5
Mutual capacitance values of different sensing units when a 7 phi touch
object touches the touch panel 100 having the charge-locked electrode

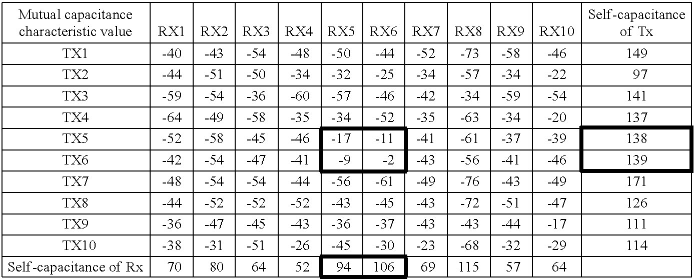

TABLE 6
Mutual capacitance characteristic values of different sensing units when a 7 phi
touch object touches the touch panel 100 without the charge-locked electrode.

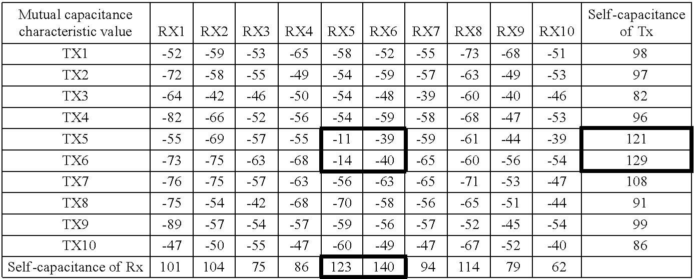

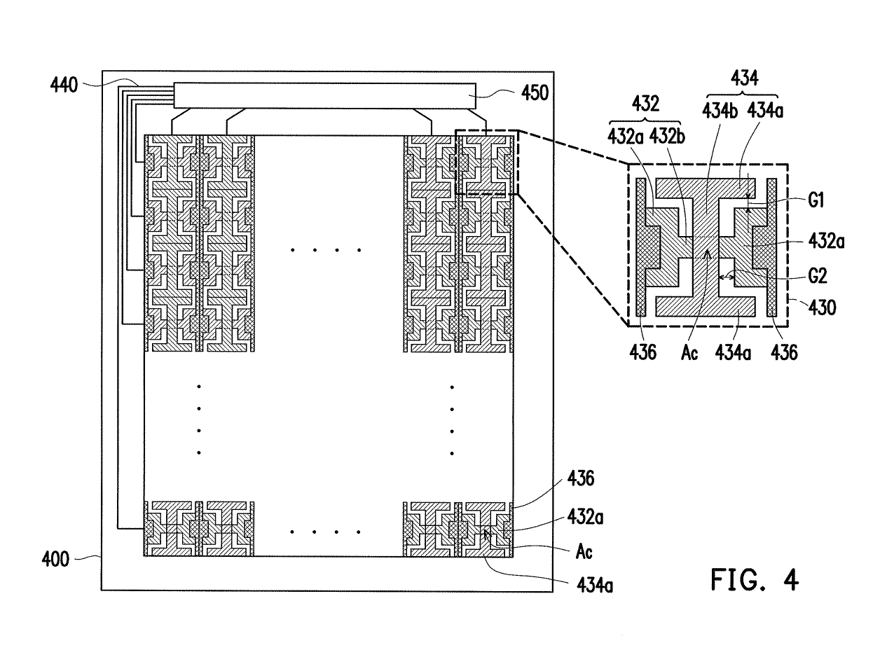

FIG. 4 is a schematic view illustrating a layout structure of a touch panel 400 according to another embodiment of the invention. Description concerning the embodiment shown in FIG. 4 may be referred to FIGS. 2 and 3. Referring to FIGS. 3 and 4, the touch panel 400 of this embodiment includes the protective layer G, the upper film layer F1, the lower film layer F2, and a plurality of sensing units 430. One of the sensing units 430 includes a first sensing electrode 432, a second sensing electrode 434, and a charge-locked electrode 436. The first sensing electrode 432, the second sensing electrode 434, and the charge-locked electrode 436 is disposed on the touch panel 400 in an arrangement of crucifix type. Materials of the first sensing electrode 432, the second sensing electrode 434, and/or the charge-locked electrode 436 may be any conductive material, such as a transparent conductive material, like indium tin oxide (ITO), or a non-transparent material, like metal. The first sensing electrode 432 is disposed in the lower film layer F2. The second sensing electrode 434 is disposed in the upper film layer F1, and at least partially overlaps the first sensing electrode 432. The charge-locked electrode 436 is disposed in the upper film layer F1, and at least partially overlaps the second sensing electrode 432. The first sensing electrode 432, the second sensing electrode 434, and the charge-locked electrode 436 do not contact each other. The first sensing electrode 432, the second sensing electrode 434, and the charge-locked electrode 436 shown in FIG. 4 may be referred to relevant description concerning the first sensing electrode 132, the second sensing electrode 134, and the charge-locked electrode 136 shown in FIG. 1.

The first sensing electrode 432 and the second sensing electrode 434 are arranged in a staggered manner and insulated from each other. The first sensing electrode 432 and the charge-locked electrode 436 are arranged in a staggered manner and insulated from each other. Here, to make the description clear and avoid overlapping of lines, only half of components disposed in symmetry in FIG. 4 are marked with reference numerals, while markings of the same components in the other half are omitted. In an identical sensing unit 430, the first sensing electrode 432 includes two first sensing pads 432a arranged in parallel 432a and a first connection portion 432b. In addition, shapes of the first sensing pads 432a and the first connection portion 432b are rectangular. As shown in FIG. 4, two short sides of the first connection portion 432b are respectively electrically connected to middle portions of long sides of the first sensing pads 432a. In this embodiment, the first connection portion 432b and the first sensing pads 432a are in a vertical arrangement, for example. However, the invention is not limited thereto.

The second sensing electrode 434 includes two sensing pads 434a arranged in parallel and a second connection portion 434b. In addition, shapes of the second sensing pads 434a and the second connection portion 434b are rectangular. As shown in FIG. 4, two short sides of the second connection portion 432b are respectively electrically connected to middle portions of long sides of the second sensing pads 434a. In this embodiment, the second connection portion 434b and the second sensing pads 434a are in a vertical arrangement, for example. However, the invention is not limited thereto. An included angle between the second connection portion 434b and the second sensing pads 434a is determined based on the product requirement.

Specifically, the second connection portion 434b and the first connection portion 432b of this embodiment intersect (overlap) each other, and a position where the second connection portion 434b and the first connection portion 432b overlap has an overlapped area A_{C}. In this embodiment, the first connection portion 432b and the second connection portion 434b perpendicularly intersect each other, while the first sensing pads 432a and the second sensing pads 434a do not overlap each other. In addition, there are a plurality of first gaps G1 between the first sensing pads 432a and the second sensing pads 434a, and there are a plurality of second gaps G2 between the first sensing pads 432a and the second connection portion 434b. In this embodiment, a width of the first gap is in a range from 0.1 mm to 0.3 mm. However, the invention is not limited thereto.

In addition, the touch panel 400 of this embodiment further includes a plurality of signal lines 440 and a controller 450. The first sensing electrode 432 and the second sensing electrode 434 are respectively electrically connected to the controller 450 through different signal lines 440. It should be noted that a relative electrical connection relation between each of the signal lines 440 and the first sensing electrode 432 and the second sensing electrode 434 is illustrated in FIG. 4 merely for an illustrative purpose. In the actual application, precise wiring positions of the signal lines 440 may be hidden in other suitable positions based on the practical needs, and are not limited to be the same as the layout shown in FIG. 4. In an actual operating mechanism, when the user touches the touch panel 400 to make the touched position generate a change of capacitance, the touched sensing unit 430 may immediately transmit the capacitance change signal to the controller 450 through the signal line 440, so as to determine the user's touch position.

The charge-locked electrode 436 is configured to be coupled to or floating-connect to a constant voltage. For example (however, the invention is not limited thereto), in some embodiments, the charge-locked electrode 436 may be constantly connected to a ground voltage. In some other embodiments, the charge-locked electrode 436 may be connected to any reference voltage having a constant level. In other embodiments, the charge-locked electrode 436 may be floating-connected. Namely, the charge-locked electrode 436 is not connected to any conductive material or electrical component. Thus, the charge-locked electrode 436 may not serve as a driving electrode or a receiving electrode.

Referring to FIGS. 3 and 4, under the circumstance that the user does not hold the information technology product having the touch panel 400, the reference voltage of the touch panel 400 may be in a floating-connecting state (i.e., low ground mode (LGND)), such that the reference voltage of the touch panel 400 may be different from the voltage of the touch object 200. Under this circumstance, the charge-locked electrode 436 between the first sensing electrode 432 and the touch object 200 may absorb a capacitance of the first sensing electrode 432 through the touch object 200 and reduce a mutual capacitance path where the first sensing electrode 432 is serially connected to the second sensing electrode 434 through the touch object 200. Regarding the application of the ultra-slim protective layer G, the charge-locked electrode 436 may improve a variance of mutual capacitance, increase a signal-to-noise ratio (SNR), and help reduce a chance/probability that a ghost point occurs. Accordingly, a touch sensitivity of the touch panel 400 in a non-handheld environment may be improved.

Exemplary data are provided in the following to demonstrate characteristics of the touch panel 400 shown in FIG. 4. However, it should be noted that the embodiment of the touch panel 400 is not limited thereto. Here, it is assumed that a dielectric constant of the protective layer G is 7.4, a thickness of the protective G is 0.4 mm, a dielectric constant of an adhesive layer (not shown) between the protective layer G and the upper film layer F1 is 3.92, a thickness of the adhesive layer is 0.1 mm, a dielectric constant of the upper film layer F1 is 3.9, a thickness of the upper film layer F1 is 0.045 mm, a dielectric constant of the lower film layer F2 is 3.28, and a thickness of the lower film layer F2 is 0.05 mm. Besides, the first sensing electrode 432 serves as a driving electrode (also referred to as Tx electrode) here, while the second sensing electrode 434 serves as a receiving electrode (also referred to as Rx electrode) here. Table 7 illustrates capacitance values of the sensing unit 430 when the touch panel 400 is not touched. Table 7 also illustrates capacitance values of the sensing unit of the touch panel 400 when the charge-locked electrode 436 of the touch panel 400 is removed.

TABLE 7
Capacitance values when the touch panel 400 shown in FIG. 4
is not touched

| | Self-capacitance | Self-capacitance | Mutual |
|---|---|---|---|
| | (pF) of Tx | (pF) of Rx | capacitance |
| | Electrode | Electrode | (pF) |
| Charge-locked | 2.59 | 1.39 | 0.61 |
| electrode not | | | |
| disposed | | | |
| Charge-locked | 5.37 | 1.43 | 0.64 |
| electrode disposed | | | |

Table 8 illustrates capacitance values of the sensing unit 430 when the touch object 200 touches the touch panel 400. When a diameter of the touch object 200 is 22 mm (22 phi), and the user holds the information technology product having the touch panel 400, a mutual capacitance variance ΔC of the sensing unit 430 having the charge-locked electrode 436 is 0.17 pF, and the mutual capacitance variance ΔC of the sensing unit without the charge-locked electrode 436 is 0.19 pF. When the diameter of the touch object is 22 mm (22 phi), and the user does not hold the information technology product having the touch panel 400, the mutual capacitance variance ΔC of the sensing unit 430 having the charge-locked electrode 436 is −0.02 pF, and the mutual capacitance variance ΔC of the sensing unit without the charge-locked electrode 436 is −0.1 pF. When the diameter of the touch object 200 is 7 mm (7 phi), and the user holds the information technology product having the touch panel 400, the mutual capacitance variance ΔC of the sensing unit 430 having the charge-locked electrode 436 is 0.1 pF, and the mutual capacitance variance ΔC of the sensing unit without the charge-locked electrode 436 is 0.14 pF. When the diameter of the touch object is 7 mm (7 phi), and the user does not hold the information technology product having the touch panel 400, the mutual capacitance variance ΔC of the sensing unit 430 having the charge-locked electrode 436 is 0.06 pF, and the mutual capacitance variance ΔC of the sensing unit without the charge-locked electrode 436 is 0.07 pF.

TABLE 8
Capacitance values when the touch object 200 touches the touch panel 400
shown in FIG. 4

| | 22 phi | | 7 phi | |
|---|---|---|---|---|
| | Mutual | Mutual | Mutual | Mutual |
| | capacitance | capacitance | capacitance | capacitance |
| | variance (pF) in | variance (pF) in | variance (pF) in | variance (pF) in |
| | handheld | non-handheld | handheld | non-handheld |
| | condition | condition | condition | condition |
| Charge-locked | 0.19 | −0.1 | 0.14 | 0.07 |
| electrode not | | | | |
| disposed | | | | |
| Charge-locked | 0.17 | −0.02 | 0.1 | 0.06 |
| electrode disposed | | | | |

Table 9 illustrates mutual capacitance characteristic values of different sensing units 430 of the touch panel 400 when the touch object 200 of 22 phi (diameter thereof is 22 mm) touches the center of the touch panel 400 having the charge-locked electrode 436. Table 10 illustrates mutual capacitance characteristic values of different sensing units when the touch object 200 of 22 phi (diameter thereof is 22 mm) touches the center of the touch panel 400 without the charge-locked electrode 436. Here, Rx1, Rx2, Rx3, Rx4, Rx5, Rx6, Rx7, Rx8, Rx9, and Rx10 represent different second sensing electrodes 434, while Tx1, Tx2, Tx3, Tx4, Tx5, Tx6, Tx7, Tx8, Tx9, and Tx10 represent different first sensing electrodes 432. Based on Tables 9 and 10, it can be seen that the mutual capacitance characteristic values (e.g., the mutual capacitance characteristic values −11, 1, −12, and -3 at the position of the touch object 200) of the touch panel 400 having the charge-locked electrode 436 are greater than the mutual capacitance characteristic values (e.g., the mutual capacitance characteristic values −38, −53, −39, and -16) of the touch panel 400 without the charge-locked electrode 436. It can thus be known that the charge-locked electrode 436 may improve the mutual capacitance variance. Accordingly, the touch sensitivity of the touch panel 400 having the charge-locked electrode 436 in the non-handheld environment may be improved.

TABLE 9
Mutual capacitance characteristic values of different sensing units when a 22
phi touch object touches the touch panel 400 having the charge-locked electrode.

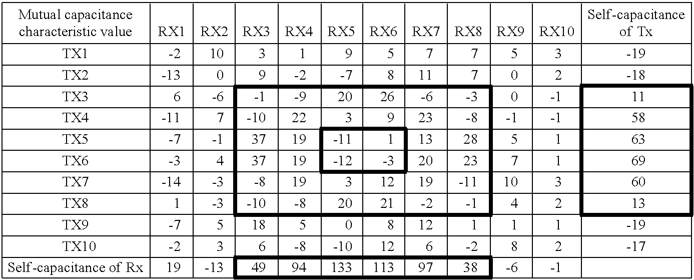

TABLE 10
Mutual capacitance characteristic values of different sensing units when a 22
phi touch object touches the touch panel 400 with the charge-locked electrode removed.

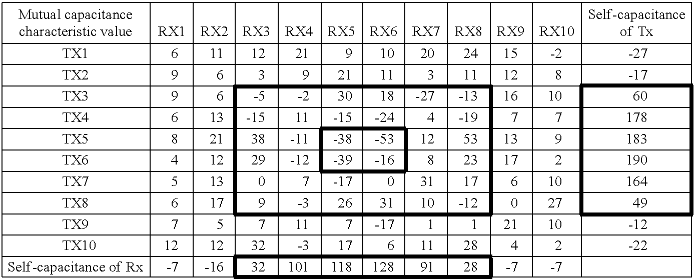

Table 11 illustrates mutual capacitance characteristic values of different sensing units 430 of the touch panel 400 when the touch object 200 of 7 phi (diameter thereof is 7 mm) touches the touch panel 400 having the charge-locked electrode 436. Table 12 illustrates mutual capacitance characteristic values of different sensing units when the touch object 200 of 7 phi (diameter thereof is 7 mm) touches the touch panel 400 without the charge-locked electrode 436. Based on Tables 11 and 12, it can be seen that the mutual capacitance characteristic values (e.g., the mutual capacitance characteristic values 41, 57, 31, and 51 at the position of the touch object 200) of the touch panel 400 having the charge-locked electrode 436 are greater than the mutual capacitance characteristic values (e.g., the mutual capacitance characteristic values 43, 33, 40, and 36) of the touch panel 400 without the charge-locked electrode 436. It can thus be known that the charge-locked electrode 436 may improve the mutual capacitance variance. Accordingly, the touch sensitivity of the touch panel 400 having the charge-locked electrode 436 in the non-handheld environment may be improved, and a coaxial effect may be reduced.

TABLE 11
Mutual capacitance values of different sensing units when a 7 phi touch
object touches the touch panel 400 having the charge-locked electrode

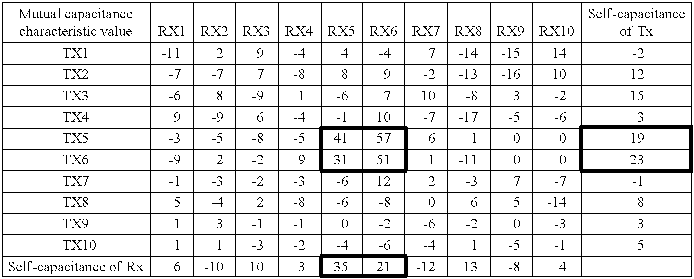

TABLE 12
Mutual capacitance characteristic values of different sensing units when a 7
phi touch object touches the touch panel 400 without the charge-locked electrode.

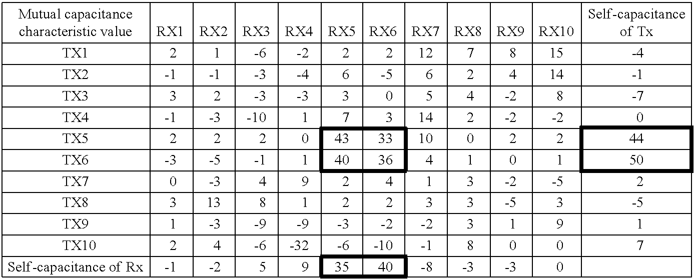

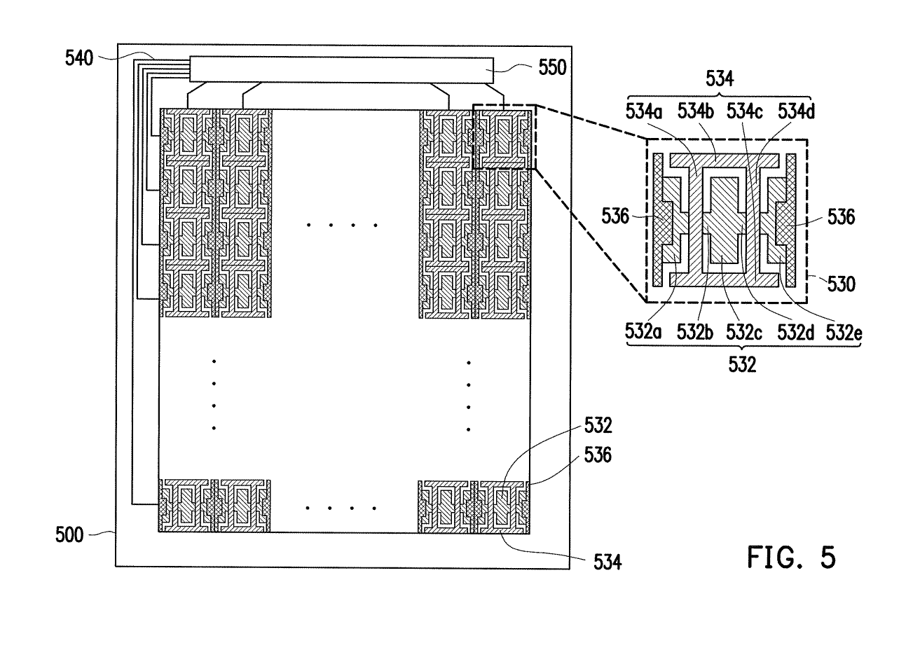

FIG. 5 is a schematic view illustrating a layout structure of a touch panel 500 according to yet another embodiment of the invention. Description concerning the embodiment shown in FIG. 5 may be referred to FIGS. 2 and 3. Referring to FIGS. 3 and 5, the touch panel 500 of this embodiment includes the protective layer G, the upper film layer F1, the lower film layer F2, and a plurality of sensing units 530. One of the sensing units 530 includes a first sensing electrode 532, a second sensing electrode 534, and a charge-locked electrode 536. Materials of the first sensing electrode 532, the second sensing electrode 534, and/or the charge-locked electrode 536 may be any conductive material, such as a transparent conductive material, like indium tin oxide (ITO), or a non-transparent material, like metal. The first sensing electrode 532 is disposed in the lower film layer F2. The second sensing electrode 534 is disposed in the upper film layer F1, and at least partially overlaps the first sensing electrode 532. The charge-locked electrode 536 is disposed in the upper film layer F1, and at least partially overlaps the second sensing electrode 532. The first sensing electrode 532, the second sensing electrode 534, and the charge-locked electrode 536 do not contact each other. The first sensing electrode 532, the second sensing electrode 534, and the charge-locked electrode 536 shown in FIG. 5 may be referred to the first sensing electrode 132, the second sensing electrode 134, and the charge-locked electrode 136 shown in FIG. 1, or may be referred to the first sensing electrode 432, the second sensing electrode 434, and the charge-locked electrode 436.

The first sensing electrode 532 and the second sensing electrode 534 are arranged in a staggered manner and insulated from each other. The first sensing electrode 532 and the charge-locked electrode 536 are arranged in a staggered manner and insulated from each other. In an identical sensing unit 530, the first sensing electrode 532 includes a first sensing pad 532a, a second sensing pad 532c, a third sensing pad 532e, a first connection portion 532b, and a second connection portion 532d. Shapes of the first sensing pad 532a, the second sensing pad 532c, the third sensing pad 532e, the first connection portion 532b, and the second connection portion 532d are rectangular. As shown in FIG. 5, the first sensing pad 532a, the second sensing pad 532c, and the third sensing pad 532e are parallel to each other. Two short sides of the first connection portion 532b are respectively electrically connected to a middle portion of a long side of the first sensing pad 532a and a middle portion of a first long side of the second sensing pad 532c. Two short sides of the second connection portion 532d are respectively electrically connected to a middle portion of a second long side of the second sensing pad 532c and a middle portion of a long side of the third sensing pad 532e.

The second sensing electrode 534 includes a fourth sensing pad 534b, a fifth sensing pad 534c, a third connection portion 534a, and a fourth connection portion 534d. Shapes of the fourth sensing pad 534b, the fifth sensing pad 534c, the third connection portion 534a, and the fourth connection portion 534d are rectangular. Two short sides of the third connection portion 534a are respectively electrically connected to a long side of the fourth sensing pad 534b and a long side of the fifth sensing pad 534c, and two short sides of the fourth connection portion 534d are respectively electrically connected to the long side of the fourth sensing pad 534b and the long side of the fifth sensing pad 534c. The third connection portion 534a and the first connection portion 532b may intersect each other, and the fourth connection portion 534b and the second connection portion 532d intersect each other.

As shown in FIG. 5, in this embodiment, the third connection portion 534a and the first connection portion 532b perpendicularly intersect each other, the fourth connection portion 534d and the second connection portion 532d perpendicularly intersect each other, and the first sensing pad 532a, the second sensing pad 532c, the third sensing pad 532e, the fourth sensing pad 534d, and the fifth sensing pad 534c do not overlap each other. However, the invention is not limited thereto.

In addition, the touch panel 500 of this embodiment further includes a plurality of signal lines 540 and a controller 550. The first sensing electrode 532 and the second sensing electrode 534 are respectively electrically connected to the controller 550 through different signal lines 540. It should be noted that a relative electrical connection relation between each of the signal lines 540 and the first sensing electrode 532 and the second sensing electrode 534 is illustrated in FIG. 5 merely for an illustrative purpose. In the actual application, precise wiring positions of the signal lines 540 may be hidden in other suitable positions based on the practical needs, and are not limited to be the same as the layout shown in FIG. 5. In an actual operating mechanism, when the user touches the touch panel 500 to make the touched position generate a change of capacitance, the touched sensing unit 530 may immediately transmit the capacitance change signal to the controller 550 through the signal line 540, so as to determine the user's touch position.

The charge-locked electrode 536 is configured to be coupled to or floating-connect to a constant voltage. For example (however, the invention is not limited thereto), in some embodiments, the charge-locked electrode 536 may be constantly connected to a ground voltage. In some other embodiments, the charge-locked electrode 536 may be connected to any reference voltage having a constant level. In other embodiments, the charge-locked electrode 536 may be floating-connected. Namely, the charge-locked electrode 536 is not connected to any conductive material or electrical component. Thus, the charge-locked electrode 536 may not serve as a driving electrode or a receiving electrode.

Referring to FIGS. 3 and 5, under the circumstance that the user does not hold the information technology product having the touch panel 500, the reference voltage of the touch panel 500 may be in a floating-connecting state (i.e., low ground mode (LGND)), such that the reference voltage of the touch panel 500 may be different from the voltage of the touch object 200. Under this circumstance, the charge-locked electrode 536 between the first sensing electrode 532 and the touch object 200 may absorb a capacitance of the first sensing electrode 532 through the touch object 200 and reduce a mutual capacitance path where the first sensing electrode 532 is serially connected to the second sensing electrode 534 through the touch object 200. Regarding the application of the ultra-slim protective layer G, the charge-locked electrode 536 may improve a variance of mutual capacitance, increase a signal-to-noise ratio (SNR), and help reduce a chance that a ghost point occurs. Accordingly, a touch sensitivity of the touch panel 500 in a non-handheld environment may be improved.

Exemplary data are provided in the following to demonstrate characteristics of the touch panel 500 shown in FIG. 5. However, it should be noted that the embodiment of the touch panel 500 is not limited thereto. Here, it is assumed that the dielectric constant of the protective layer G is 7.4, the thickness of the protective G is 0.4 mm, the dielectric constant of the adhesive layer (not shown) between the protective layer G and the upper film layer F1 is 3.92, the thickness of the adhesive layer is 0.1 mm, the dielectric constant of the upper film layer F1 is 3.9, the thickness of the upper film layer F1 is 0.045 mm, the dielectric constant of the lower film layer F2 is 3.28, and the thickness of the lower film layer F2 is 0.05 mm. Besides, the first sensing electrode 532 serves as a driving electrode (also referred to as Tx electrode) here, while the second sensing electrode 534 serves as a receiving electrode (also referred to as Rx electrode) here. Table 13 illustrates capacitance values of the sensing unit 530 when the touch panel 500 is not touched. Table 13 also illustrates capacitance values of the sensing unit of the touch panel 500 when the charge-locked electrode 536 of the touch panel 400 is removed.

TABLE 13
Capacitance values when the touch panel 500 shown in
FIG. 5 is not touched

| | Self- | Self- | |
|---|---|---|---|
| | capacitance | capacitance | Mutual |
| | (pF) of Tx | (pF) of Rx | capacitance |
| | Electrode | Electrode | (pF) |
| Charge-locked electrode not | 2.50 | 1.82 | 0.83 |
| disposed | | | |
| Charge-locked electrode | 4.04 | 1.878 | 0.84 |
| disposed | | | |

Table 14 illustrates capacitance values of the sensing unit 530 when the touch object 200 touches the touch panel 500. When the diameter of the touch object 200 is 22 mm (22 phi), and the user holds the information technology product having the touch panel 500, the mutual capacitance variance ΔC of the sensing unit 530 having the charge-locked electrode 536 is 0.24 pF, and the mutual capacitance variance ΔC of the sensing unit without the charge-locked electrode 536 is 0.29 pF. When the diameter of the touch object is 22 mm (22 phi), and the user does not hold the information technology product having the touch panel 500, the mutual capacitance variance ΔC of the sensing unit 530 having the charge-locked electrode 536 is −0.02 pF, and the mutual capacitance variance ΔC of the sensing unit without the charge-locked electrode 536 is −0.03 pF. When the diameter of the touch object 200 is 7 mm (7 phi), and the user holds the information technology product having the touch panel 500, the mutual capacitance variance ΔC of the sensing unit 530 having the charge-locked electrode 536 is 0.15 pF, and the mutual capacitance variance ΔC of the sensing unit without the charge-locked electrode 536 is 0.12 pF. When the diameter of the touch object is 7 mm (7 phi), and the user does not hold the information technology product having the touch panel 500, the mutual capacitance variance ΔC of the sensing unit 530 having the charge-locked electrode 536 is 0.09 pF, and the mutual capacitance variance ΔC of the sensing unit without the charge-locked electrode 536 is 0.05 pF.

TABLE 14
Capacitance values when the touch object 200 touches the touch panel 500
shown in FIG. 5

| | 22 phi | | 7 phi | |
|---|---|---|---|---|
| | Mutual | Mutual | Mutual | Mutual |
| | capacitance | capacitance | capacitance | capacitance |
| | variance (pF) in | variance (pF) in | variance (pF) in | variance (pF) in |
| | handheld | non-handheld | handheld | non-handheld |
| | condition | condition | condition | condition |
| Charge-locked | 0.29 | −0.03 | 0.12 | 0.05 |
| electrode not disposed | | | | |
| Charge-locked | 0.24 | −0.02 | 0.15 | 0.09 |
| electrode disposed | | | | |

Table 15 illustrates mutual capacitance characteristic values of different sensing units 530 of the touch panel 500 when the touch object 200 of 22 phi (diameter thereof is 22 mm) touches the center of the touch panel 500 having the charge-locked electrode 536. Table 16 illustrates mutual capacitance characteristic values of different sensing units when the touch object 200 of 22 phi (diameter thereof is 22 mm) touches the center of the touch panel 500 without the charge-locked electrode 536. Here, Rx1, Rx2, Rx3, Rx4, Rx5, Rx6, Rx7, Rx8, Rx9, and Rx10 represent different second sensing electrodes 534, while Tx1, Tx2, Tx3, Tx4, Tx5, Tx6, Tx7, Tx8, Tx9, and Tx10 represent different first sensing electrodes 532. Based on Tables 15 and 16, it can be seen that the mutual capacitance characteristic values (e.g., the mutual capacitance characteristic values −7, −5, −13, and -10 at the position of the touch object 200) of the touch panel 500 having the charge-locked electrode 536 are greater than the mutual capacitance characteristic values (e.g., the mutual capacitance characteristic values −14, −13, −8, and -15) of the touch panel 500 without the charge-locked electrode 536. It can thus be known that the charge-locked electrode 536 may improve the mutual capacitance variance. Accordingly, the touch sensitivity of the touch panel 500 having the charge-locked electrode 536 in the non-handheld environment may be improved.

TABLE 15
Mutual capacitance characteristic values of different sensing units when a 22
phi touch object touches the touch panel 500 having the charge-locked electrode.

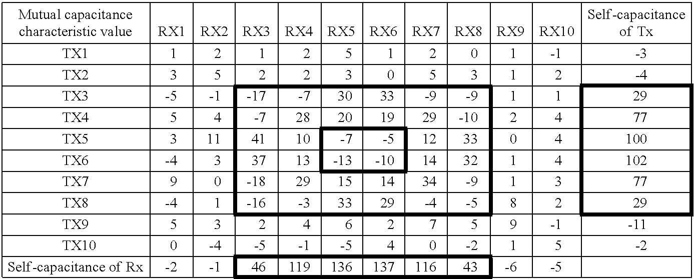

TABLE 16
Mutual capacitance characteristic values of different sensing units when a 22
phi touch object touches the touch panel 500 with the charge-locked electrode removed.

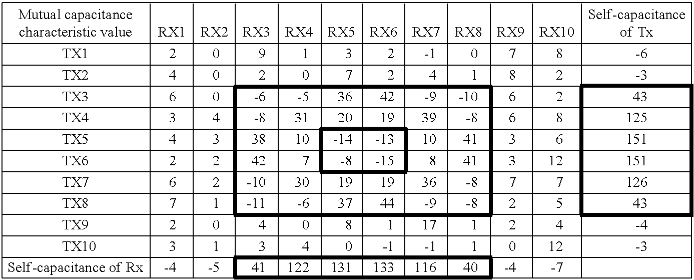

Table 17 illustrates mutual capacitance characteristic values of different sensing units 530 of the touch panel 500 when the touch object 200 of 7 phi (diameter thereof is 7 mm) touches the touch panel 500 having the charge-locked electrode 536. Table 18 illustrates mutual capacitance characteristic values of different sensing units when the touch object 200 of 7 phi (diameter thereof is 7 mm) touches the touch panel 500 without the charge-locked electrode 536. Based on Tables 17 and 18, it can be seen that the mutual capacitance characteristic values (e.g., the mutual capacitance characteristic values 48, 50, 43, and 45 at the position of the touch object 200) of the touch panel 500 having the charge-locked electrode 536 are greater than the mutual capacitance characteristic values (e.g., the mutual capacitance characteristic values 41, 37, 37, and 25) of the touch panel 500 without the charge-locked electrode 536. It can thus be known that the charge-locked electrode 536 may improve the mutual capacitance variance. Accordingly, the touch sensitivity of the touch panel 500 having the charge-locked electrode 536 in the non-handheld environment may be improved, and a coaxial effect may be reduced.

TABLE 17
Mutual capacitance characteristic values of different sensing units when a 7
phi touch object touches the touch panel 500 having the charge-locked electrode.

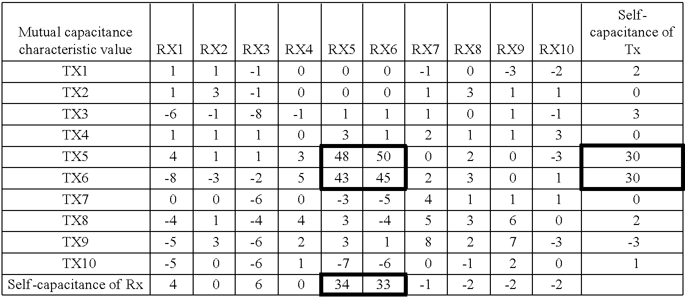

TABLE 18
Mutual capacitance characteristic values of different sensing units when a 7
phi touch object touches the touch panel 500 without the charge-locked electrode.

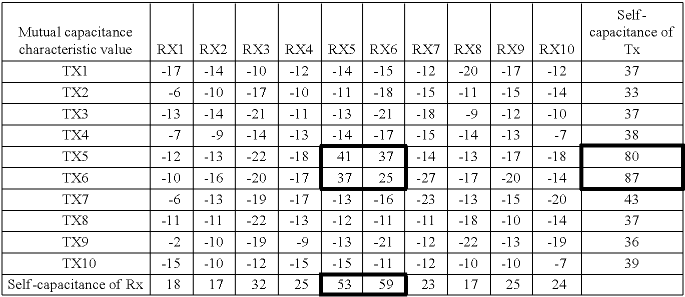

In view of foregoing, in the touch panel (touch panel 100, 400, or 500) according to the embodiments of the invention, the charge-locked electrode (charge-locked electrode 136, 436, or 536) is additionally disposed between the first sensing electrode (first sensing electrode 132, 432, or 532) and the touch object to absorb the capacitance of the first sensing electrode through the touch object. Accordingly, the touch sensitivity of the touch panel according to the embodiments may be improved in the non-handheld environment.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A touch panel, comprising:
a lower film layer;
an upper film layer, disposed on the lower film layer;
a protective layer, disposed on the upper film layer; and
a plurality of sensing units, wherein one of the sensing units comprises a first sensing electrode, a second sensing electrode, and a charge-locked electrode, the first sensing electrode is disposed in the lower film layer, the second sensing electrode is disposed in the upper film layer and at least partially overlaps the first sensing electrode, the charge-locked electrode is disposed in the upper film layer and at least partially overlaps the first sensing electrode, wherein the first sensing electrode, the second sensing electrode, and the charge-locked electrode do not contact each other, and the charge-locked electrode is configured to be floating-connected or coupled to a constant voltage.

2. The touch panel as claimed in claim 1, wherein the constant voltage is a ground voltage or a reference voltage having a constant level.

3. The touch panel as claimed in claim 1, wherein the first sensing electrode is a driving electrode, and the second sensing electrode is a receiving electrode.

4. The touch panel as claimed in claim 1, wherein the first sensing electrode is a receiving electrode, and the second sensing electrode is a driving electrode.

5. The touch panel as claimed in claim 1, wherein the second sensing electrode and the first sensing electrode are arranged in a staggered manner, and the charge-locked electrode and the first sensing electrode are arranged in a staggered manner.

6. The touch panel as claimed in claim 5, wherein in an identical sensing unit of the sensing units, the first sensing electrode comprises two first sensing pads arranged in parallel and a first connection portion, shapes of the first sensing pads and the first connection portion are rectangular, two short sides of the first connection portion are respectively electrically connected to middle portions of long sides of the first sensing pads, the second sensing electrode comprises two second sensing pads disposed in parallel and a second connection portion, shapes of the second sensing pads and the second connection portion are rectangular, two short sides of the second connection portion are respectively electrically connected to middle portions of long sides of the second sensing pads, and the second connection portion intersects the first connection portion.

7. The touch panel as claimed in claim 6, wherein in the identical sensing unit, the first connection portion and the second connection portion perpendicularly intersect each other, and the first sensing pads and the second sensing pads do not overlap each other.

8. The touch panel as claimed in claim 5, wherein in an identical sensing unit of the sensing units, the first sensing electrode comprises a first sensing pad, a second sensing pad, a third sensing pad, a first connection portion, and a second connection portion that are in rectangular shapes, the first sensing pad, the second sensing pad, and the third sensing pad are parallel to each other, two short sides of the first connection portion are respectively electrically connected with a middle portion of a long side of the first sensing pad and a middle portion of a first long side of the second sensing pad, two short sides of the second connection portion are respectively electrically connected with a middle portion of a second long side of the second sensing pad and a middle portion of a long side of the third sensing pad, the second sensing electrode comprises a fourth sensing pad, a fifth sensing pad, a third connection portion, and a fourth connection portion that are in rectangular shapes, two short sides of the third connection portion are respectively electrically connected to a long side of the fourth sensing pad and a long side of the fifth sensing pad, two short sides of the fourth connection portion are respectively electrically connected to the long side of the fourth sensing pad and the long side of the fifth sensing pad, the third connection portion intersects the first connection portion, and the fourth connection portion intersects the second connection portion.

9. The touch panel as claimed in claim 8, wherein in the identical sensing unit, the first connection portion and the third connection portion perpendicularly intersect each other, the second connection portion and the fourth connection portion perpendicularly intersect each other, and the first sensing pad, the second sensing pad, the third sensing pad, the fourth sensing pad, and the fifth sensing pad do not overlap each other.

10. The touch panel as claimed in claim 1, further comprising:
a plurality of signal lines; and
a controller, wherein the first sensing electrodes and the second sensing electrodes are respectively electrically connected to the controller through the signal lines.
